(19) United States
(12) Patent Application Publication
(10) Pub. No.: US 2008/0215237 A1
(43) Pub. Date: Sep. 4, 2008

(54) DESIGN STRUCTURE FOR ADAPTIVE ROUTE PLANNING FOR GPS-BASED NAVIGATION

(75) Inventor: Patrick E. Perry, Shelburne, VT (US)

Correspondence Address: FREDERICK W. GIBB, III;Gibb & Rahman, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 12/054,685

(22) Filed: Mar. 25, 2008

Related U.S. Application Data
(63) Continuation-in-part of application No. 11/383,786, filed on May 17, 2006.

(51) Int. Cl. G01C 21/34; G01S 5/00

(52) U.S. Cl. 701/209

(57) ABSTRACT

Disclosed herein is a design structure for route planning for global positioning system (GPS) based navigation systems. The method identifies route segments used in a GPS based navigation system and records an actual historical time of travel for at least one route segment traveled by users of the GPS based navigation system travel. The actual historical time of travel comprises the amount of time taken by a user of the GPS based navigation system to go from a beginning of the route segment to an end of the route segment. With embodiments herein, the day and time that the route segment was recorded is also noted. Then, the actual historical time of travel and the day and time for the route segment can be stored in a database. This information can be stored for a single-user or can be combined from a plurality users of the GPS based navigation systems.

### CROSS-REFERENCE TO RELATED APPLICATIONS

This application is a Continuation-In-Part of U.S. application Ser. No. 11/383,786 filed May 17, 2006, the complete disclosure of which, in its entirety, is herein incorporated by reference.

### BACKGROUND OF THE INVENTION

1. Field of the Invention

The invention generally relates to a design structure for route planning for global positioning system (GPS) based navigation systems and more particularly to a method that identifies route segments used in a GPS based navigation system and records an actual historical time of travel for at least one route segment traveled by users of the GPS based navigation system.

2. Description of the Related Art

GPS based navigation systems available today use stored maps to do route planning based on distance, speed limits and user preference of types of roads. The resulting route chosen is adequate, but not necessarily the best. For example, see U.S. Patent Publication 2006/0031566 (which is incorporated herein by reference) that discloses a GPS system that uses a Vehicle Information and Communication System (VICS), in which real time traffic information is transmitted to users to allow the GPS system to determine the shortest-route, in terms of either distance or time, and determine real-time congestion information over all legs of a route. There are many factors that could be used to improve route planning, but are currently beyond the ability of the map makes to adequately address, such as time of day, day of the week, local traffic patterns, number and length of traffic light, etc. GPS based navigation is great for getting to someplace new, but not really much help driving in a familiar locale. But even in locales that you are very familiar, there are typically many possible routes to get from point A to point B, and it is not clear to even experienced local drivers which route is the best choice at any given time.

### SUMMARY OF THE INVENTION

Disclosed herein is a design structure for route planning for global positioning system (GPS) based navigation systems. The method identifies route segments used in a GPS based navigation system and records an actual historical time of travel for at least one route segment traveled by users of the GPS based navigation system. The actual historical time of travel comprises the amount of time taken by a user of the GPS based navigation system on a previous trip to go from a beginning of the route segment to an end of the route segment. With embodiments herein, the date, day of the week, and time that the route segment was recorded are also noted. Then, the actual historical time of travel and the day and time for the route segment can be stored in a database. This information can be stored for a single-user or can be combined from a plurality users of the GPS based navigation systems.

Once sufficient information is established in the database, the user can supply and the system can receive, as input, a beginning and an end of a desired route (e.g., a new route). The then current day and time is also supplied or known by the GPS based navigation system. From the historical records within the database of the different actual travel times for the different route segments, the method can then calculate a plurality of potential travel routes between the beginning and end of the desired route (each of the potential travel routes comprises the route segments stored in the database). Subsequently, the method calculates an estimated travel time for each of the different potential travel routes using the actual historical time of travel of the route segments for the current day and time. The calculating of the estimated travel time comprises adding stored actual travel times for all route segments within each of the potential travel routes. Then the method can identify a travel route that has a shortest estimated travel time for the current day and time to allow the user to know the fastest route that will be available for the current day and time.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a flow diagram illustrating a preferred method of the invention;

FIG. 2 is a schematic diagram of a database in relation to many GPS system units; and

FIG. 3 is a flow diagram of a design process used in semiconductor design, manufacture, and/or test.

### DETAILED DESCRIPTION OF EMBODIMENTS OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

This invention comprises an adaptive route planning system where the GPS system monitors driving and builds a database of the actual historical time to traverse any road segment and the time of day and day of the week when the trip was made. After a sufficient amount of data is collected, the GPS system can use this database to calculate the best route for a trip based on actual travel times over a road segment. The system could also transfer trip data to a computer allowing data from many different drivers to be aggregated (potentially in real-time). Individual drivers could share data to build up a useful database faster. Or a company could collect and aggregate data from many drivers in a particular locale to build a valuable database that could be sold.

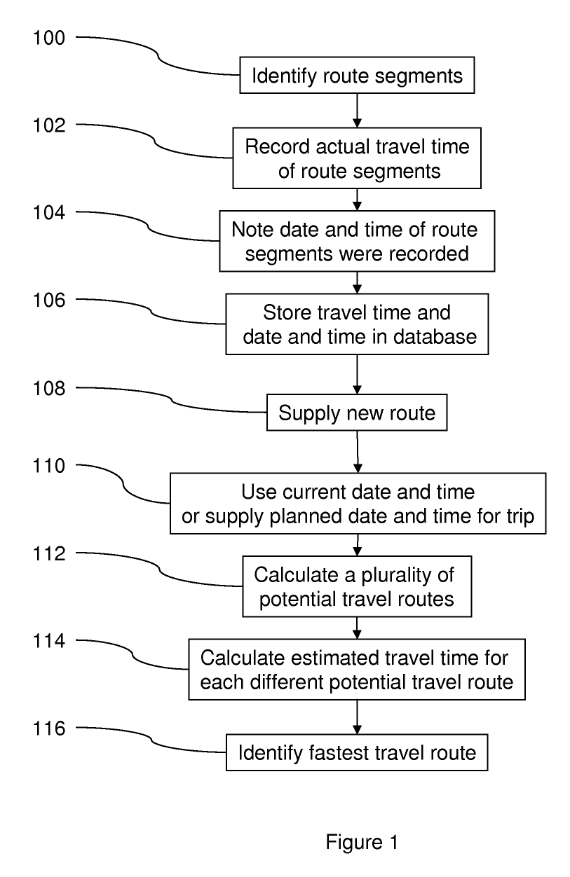

FIG. 1 is a flow diagram illustrating a method of route planning for global positioning system (GPS) based navigation systems. Beginning in item 100, the method identifies route segments used in a GPS based navigation system using, for example, some methodologies discussed in U.S. Patent Publication 2006/0031566. Conventional GPS navigation systems already have maps loaded, know each road segment, and can easily calculate the time it takes to traverse the roads assuming no traffic. Most GPS system use either a hard disk drive or a flash memory to store their maps, so this could be used to store the database of actual travel times, time of day and day of week for each time a road segment is traversed.

Typically, the route segments that are identified in item 100 are those that are identified by the GPS route creation function which is a process that is well-known to those ordinarily skill in the art and is not discussed in detail herein (see U.S. Patent Publication 2006/0031566, for example). What comprises a route segment can vary from system to system (depending upon designers requirements) or even from user to user (if users are provided various options). For example, some embodiments herein can classify a route segment according to a predetermined distance (e.g., every 5 kilometers) or a predetermined time (e.g., every 10 minutes). Alternatively, a route segment can be identified as a portion of a route occurring between two connecting points, such as between successive turns, which would essentially define each individual street, road, highway, etc. as a route segment. Thus, as one example, each time a user was directed to turn onto a different street, highway, etc., a new route segment would begin. One ordinarily skill in the art would understand that route segments can be defined in many different ways and the invention is not limited to the specific examples presented herein.

In item 102, the method records an actual historical time of travel for at least one route segment as users of the GPS based navigation system travel. The actual historical time of travel comprises the amount of time taken by a user of the GPS based navigation system to go from a beginning of the route segment to an end of the route segment. Thus, for example, each time a user of the GPS system travels with the GPS system turned on, each segment of the route is timed to provide the actual historical time of travel for that route segment. If the route segment is traveled often at the same time of day, the actual historical times of travel can be statistically analyzed to provide mean, median, and other useful information for the database. Thus, for example, in one embodiment, the database would maintain an average historical time of travel for a given route segment.

With embodiments herein, the day, date, and time that the route segment was recorded is also noted in item 104. That is, item 104 records the day of the year (allowing holidays to be noted), day of the month, day of the week (weekend versus weekday) and other information to be recorded. Further, in item 104 the “time” can comprise as granular a measure as is desired by the designer or a user (depending upon the options given to the designer and user). Thus, the time of day can be simply classified as daytime versus nighttime. Alternatively, time of day can be classified as rush-hour versus non rush-hour. Similarly, the time of day can be broken down into multiple hour units, single hour units or fractional hour units. The decision of how to classify “time” depends upon the amount of information that will be collected in the database, the storage abilities of the database and the processing capability of the GPS system. Maintaining more information in a higher granular format may provide more exact results; however, this may also tax the resources of the GPS system unnecessarily. Therefore, the embodiments herein provide the designer/user with various options depending upon the specific application of the GPS system. Again, one ordinarily skill to the art would understand that the definitions of “route segments” “date/day” as well as “time” are not limited to the examples discuss herein, and the invention is equally applicable to all uses of such terminology.

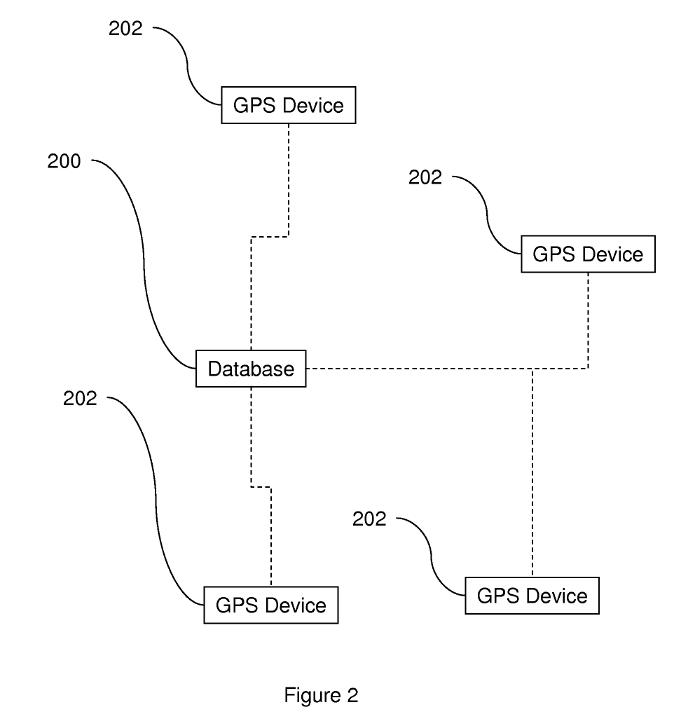

Then, the actual historical time of travel and the date/day and time for the route segment can be stored in a database in item 106. FIG. 2 illustrates a sample system whereby many individual GPS systems 202 are in wireless communication with a database 200. This information can be stored for a single-user or can be combined from a plurality users of the GPS based navigation systems. Further, such information can be truly historical or, if sufficient users are connected in real-time to the database, can actually comprise real-time or near real-time information.

The database 200 further comprises means for identifying route segments used in a GPS based navigation system and recording an actual historical time of travel for at least one route segment traveled by users of the GPS based navigation system. The actual historical time of travel comprises the amount of time taken by a user of the GPS based navigation system on a previous trip to go from a beginning of the route segment to an end of the route segment. The database 200 comprises means for noting the date, day of the week, and time that the route segment was recorded. The database 200 comprises means for storing the actual historical time of travel and the day and time for the route segment. The database 200 further comprises means for storing information for a single-user or combined from a plurality users of the GPS based navigation systems.

Once sufficient information is established in the database, the user can supply and the system can receive, as input, a beginning and an end of a desired route (e.g., a new route). The database 200 further comprises means for knowing the then current day and time. From the historical records within the database of the different actual travel times for the different route segments, the database 200 comprises means for calculating a plurality of potential travel routes between the beginning and end of the desired route (each of the potential travel routes comprises the route segments stored in the database). Subsequently, the database 200 comprises means for calculating an estimated travel time for each of the different potential travel routes using the actual historical time of travel of the route segments for the current day and time. The database 200 comprises means for calculating the estimated travel time comprises means for adding stored actual travel times for all route segments within each of the potential travel routes. The database 200 further comprises means for identifying a travel route that has a shortest estimated travel time for the current day and time to allow the user to know the fastest route that will be available for the current day and time.

Once sufficient information is established in the database, the user can supply and the system can receive, as input, a beginning and an end of a desired route (e.g. a new route) in item 108. Typically, the GPS system knows its current location and the users are required to enter a new end location for a new desired route to be calculated, as is well-known by those ordinarily skill in the art. The then current day and time is also supplied or known by the GPS based navigation system in item 110.

From the historical records within the database of the different actual travel times for the different route segments, the method can then calculate a plurality of potential travel routes between the beginning and end of the desired route (each of the potential travel routes comprises the route segments stored in the database) in item 112. Subsequently, the method calculates an estimated travel time for each of the different potential travel routes using the actual historical time of travel of the route segments for the current day and time in item 114. The calculating of the estimated travel time comprises adding stored actual travel times for all route segments within each of the potential travel routes.

The amount of information required from the database for items 112 and 114 can be adjusted by the designer or user. For example, designer/user settings may require that all route segments have an actual historical time of travel recording for the current day and time before an estimate of the entire route can be made. Alternative embodiments can allow some of the route segments to not have an actual historical time of travel. For example, in one embodiment it may be required that a predetermined percentage of the length of the entire route has an actual historical time of travel (and that predetermined percentage can be less than 100 percent). In addition, other alternative embodiments of the invention can substitute actual historical travel times for other similar route segments (or for the same route segment for a different day or different time) to be used in place of route segments for which there is no actual historical travel time. Once again, one ordinarily skill in the art would understand that the invention is not limited to these specific examples of how the travel time for the entire route is estimated, but instead, many other similar options can be provided to allow the travel time for the entire route to the estimated (without knowing the actual historical time of travel for each route segment included within the completed route).

Then the method can identify a travel route that has a shortest estimated travel time for the current day and time to allow the user to know the fastest route that will be available for the current day and time in item 116.

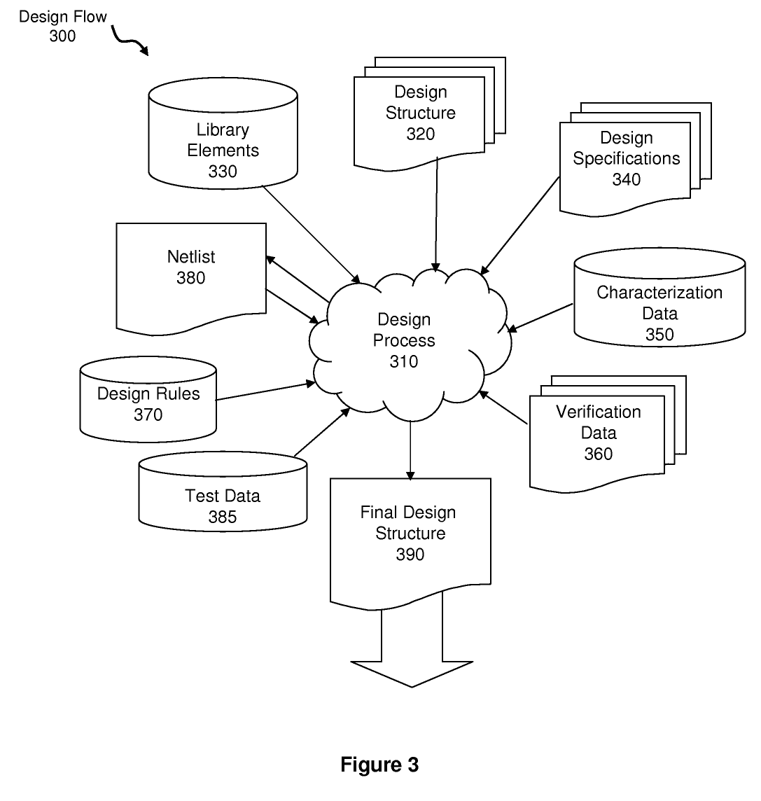

FIG. 3 shows a block diagram of an exemplary design flow 300 used for example, in semiconductor design, manufacturing, and/or test. Design flow 300 may vary depending on the type of IC being designed. For example, a design flow 300 for building an application specific IC (ASIC) may differ from a design flow 300 for designing a standard component or from a design from 300 for instantiating the design into a programmable array, for example a programmable gate array (PGA) or a field programmable gate array (FPGA) offered by Altera® Inc. or Xilinx® Inc. Design structure 320 is preferably an input to a design process 310 and may come from an IP provider, a core developer, or other design company or may be generated by the operator of the design flow, or from other sources. Design structure 320 comprises an embodiment of the invention as shown in FIG. 2 in the form of schematics or HDL, a hardware-description language (e.g., Verilog, VHDL, C, etc.), and comprises all the “means for” that are discussed with respect to FIG. 2. Design structure 320 may be contained on one or more machine readable medium. For example, design structure 320 may be a text file or a graphical representation of an embodiment of the invention as shown in FIG. 2. Design process 310 preferably synthesizes (or translates) an embodiment of the invention as shown in FIG. 2 into a netlist 380, where netlist 380 is, for example, a list of wires, transistors, logic gates, control circuits, I/O, models, etc. that describes the connections to other elements and circuits in an integrated circuit design and recorded on at least one of machine readable medium. For example, the medium may be a CD, a compact flash, other flash memory, a packet of data to be sent via the Internet, or other networking suitable means. The synthesis may be an iterative process in which netlist 380 is resynthesized one or more times depending on design specifications and parameters for the circuit.

Design process 310 may include using a variety of inputs; for example, inputs from library elements 330 which may house a set of commonly used elements, circuits, and devices, including models, layouts, and symbolic representations, for a given manufacturing technology (e.g., different technology nodes, 32 nm, 45 nm, 90 nm, etc.), design specifications 340, characterization data 350, verification data 360, design rules 370, and test data files 385 (which may include test patterns and other testing information). Design process 310 may further include, for example, standard circuit design processes such as timing analysis, verification, design rule checking, place and route operations, etc. One of ordinary skill in the art of integrated circuit design can appreciate the extent of possible electronic design automation tools and applications used in design process 310 without deviating from the scope and spirit of the invention. The design structure of the invention is not limited to any specific design flow.

Design process 310 preferably translates an embodiment of the invention as shown in FIG. 2, along with any additional integrated circuit design or data (if applicable), into a second design structure 390. Design structure 390 resides on a storage medium in a data format used for the exchange of layout data of integrated circuits and/or symbolic data format (e.g. information stored in a GDSII (GDS2), GL1, OASIS, map files, or any other suitable format for storing such design structures). Design structure 390 may comprise information such as, for example, symbolic data, map files, test data files, design content files, manufacturing data, layout parameters, wires, levels of metal, vias, shapes, data for routing through the manufacturing line, and any other data required by a semiconductor manufacturer to produce an embodiment of the invention as shown in FIG. 2. Design structure 390 may then proceed to a stage 395 where, for example, design structure 390: proceeds to tape-out, is released to manufacturing, is released to a mask house, is sent to another design house, is sent back to the customer, etc.

Thus, as shown above, this invention comprises an adaptive route planning system where the GPS system monitors driving and builds a database of the actual historical time to traverse any road segment and the time of day and day of the week when the trip was made. After a sufficient amount of data is collected, the GPS system can use this database to calculate the best route for a trip based on actual travel times over a road segment. The system could also transfer trip data to a computer allowing data from many different drivers to be aggregated potentially in real-time.

While the invention has been described in terms of preferred embodiments, those skilled in the art will recognize that the invention can be practiced with modification within the spirit and scope of the appended claims.

What is claimed is:

1. A design structure embodied in a machine readable medium, the design structure comprising a method of route planning for global positioning system (GPS) based navigation systems comprising:
means for identifying route segments used in a GPS based navigation system;
means for recording an actual historical time of travel for at least one route segment;
means for noting a day and time that said actual historical time of travel for said route segment was recorded;
means for storing said actual historical time of travel and said day and time for said route segment in a database;
means for receiving, as input, a beginning and an end of a desired route, and a current day and time;
means for calculating a plurality of potential travel routes between said beginning and end of said desired route, wherein each of said potential travel routes comprises said route segments stored in said database;
means for calculating an estimated travel time for each of said potential travel routes using said actual historical time of travel of said route segments for said current day and time; and
means for identifying a travel route that has a shortest estimated travel time for said current day and time.

2. The design structure of claim 1, all the limitations of which are incorporated herein by reference, wherein said actual historical time of travel comprises an amount of time taken by a user of said GPS based navigation system to go from a beginning of said route segment to an end of said route segment.

3. The design structure of claim 1, all the limitations of which are incorporated herein by reference, wherein said means for calculating of said estimated travel time comprises means for adding stored actual travel times for all route segments within each of said potential travel routes.

4. The design structure of claim 1, all the limitations of which are incorporated herein by reference, wherein the design structure comprises a netlist.

5. The design structure of claim 1, all the limitations of which are incorporated herein by reference, wherein the design structure resides on storage medium as a data format used for the exchange of layout data of integrated circuits.

6. The design structure of claim 1, all the limitations of which are incorporated herein by reference, all the limitations of which are incorporated herein by reference, wherein the design structure resides in a programmable gate array.

7. A design structure embodied in a machine readable medium, the design structure comprising a method of route planning for global positioning system (GPS) based navigation systems comprising:
means for identifying route segments used in a GPS based navigation system;
means for recording an actual historical time of travel for at least one route segment;
means for noting a day and time that said same route segment was recorded;
means for storing said actual historical time of travel and said day and time for said route segment in a database from a plurality users of said GPS based navigation systems;
means for receiving, as input, a beginning and an end of a desired route, and a current day and time;
means for calculating a plurality of potential travel routes between said beginning and end of said desired route, wherein each of said potential travel routes comprises said route segments stored in said database;
means for calculating an estimated travel time for each of said potential travel routes using said actual historical time of travel of said route segments for said current day and time; and
means for identifying a travel route that has a shortest estimated travel time for said current day and time.

8. The design structure of claim 7, all the limitations of which are incorporated herein by reference, wherein said actual historical time of travel comprises an amount of time taken by a user of said GPS based navigation system to go from a beginning of said route segment to an end of said route segment.

9. The design structure of claim 7, all the limitations of which are incorporated herein by reference, wherein said means for calculating of said estimated travel time comprises means for adding stored actual travel times for all route segments within each of said potential travel routes.

10. The design structure of claim 7, all the limitations of which are incorporated herein by reference, all the limitations of which are incorporated herein by reference, wherein the design structure comprises a netlist.

11. The design structure of claim 7, all the limitations of which are incorporated herein by reference, wherein the design structure resides on storage medium as a data format used for the exchange of layout data of integrated circuits.

12. The design structure of claim 7, all the limitations of which are incorporated herein by reference, all the limitations of which are incorporated herein by reference, wherein the design structure resides in a programmable gate array.
